(19) United States
(12) Patent Application Publication
(10) Pub. No.: US 2008/0245887 A1
(43) Pub. Date: Oct. 9, 2008

(54) Viscous Liquid Fountain

(75) Inventor: Andrew Cox, Revesby (AU)

Correspondence Address: CONNOLLY BOVE LODGE & HUTZ LLP, 1875 EYE STREET, N.W., SUITE 1100, WASHINGTON, DC, 20036, US

(73) Assignee: Chocloate Fountain Company Pty Ltd., Revesby (AU)

(21) Appl. No.: 11/910,839

(22) PCT Filed: Apr. 7, 2006
(86) PCT No.: PCT/AU06/00465

§ 371 Date: May 23, 2008

(30) Foreign Application Priority Data
Apr. 7, 2005 (AU) 2005901720

(51) Int. Cl. A23G 1/20

(52) U.S. Cl. 239/16; 99/483

(57) ABSTRACT

A viscous liquid fountain includes a fountain foundation (2) containing a motor (7) and a heater (5). The motor includes a drive shaft (6) extending upwardly from the fountain foundation. A viscous liquid reservoir (9) is mounted to the foundation and has one or more side walls extending a predetermined height above the base of the reservoir. The reservoir includes a sleeve (12) extending upwardly from the base of the reservoir to a height being half the side wall height to more than the side wall height. The fountain also includes an auger (14) configured for mounting over the sleeve and for engaging with the drive shaft to allow rotation of the auger. A viscous liquid reservoir is also provided. The reservoir includes a reservoir base, one or more side walls extending a predetermined height above the reservoir base and a sleeve extending upwardly from the reservoir base to about the height of the reservoir side walls. The sleeve is configured to receive a motor drive shaft there through and receive an auger there over wherein the viscous liquid reservoir is mountable to a liquid fountain foundation.

### FIELD OF THE INVENTION

The invention relates to viscous liquid fountains and, in particular, to fountains for use with edible viscous liquids.

The invention has been developed primarily for use with chocolate heated to a viscous liquid form and will be described hereinafter with reference to this application. However, it will be appreciated that the invention is not limited to this particular field of use and is also applicable to other viscous liquids such as cheese, gravy, nougat, mustard, sauces or other viscous liquids to coat edible materials with.

### BACKGROUND OF THE INVENTION

Chocolate fountains have been developed for commercial and home use. These known chocolate fountains are used to create a flow of a heated chocolate from a heating reservoir to a liquid chocolate outlet disposed at some height above the reservoir. From the chocolate outlet, liquid chocolate flows back towards the reservoir under gravity. On its way down, the float can be intercepted by an edible material which is then fully or partially coated.

A well-known chocolate fountain includes a stainless-steel pot for containing chocolate. The chocolate is placed in the pot and heated until it is at some temperature where its viscosity is sufficient to allow it to flow. The pot includes a heater with an externally mountable controller dial to allow the reservoir temperature to be preset.

An auger extends upwardly from the pot and is connected to a motor drive disposed within the pot adjacent a floor of the chocolate fountain reservoir. An auger drive controller is also disposed in the pot with an externally mountable controller to allow the augur to be rotated or not, or to be preset at a preferred speed.

The augur is connected to the motor drive through the pot. The pot is sealed about this connection to avoid any flow of liquid chocolate through the pot. A stainless-steel auger cover is disposed over the augur and a liquid chocolate inlet is disposed at a lower end of the stainless-steel augur cover to receive liquid chocolate. Rotation of the auger causes liquid chocolate to move up the augur to the liquid chocolate outlet. Liquid chocolate then flows from the outlet and is intercepted by one or more wings disposed longitudinally along the augur cover.

It is well-known that conventional chocolate fountains suffer from various disadvantages. These fountains are difficult to clean effectively and efficiently because of various crevices and small gaps that cannot be easily accessed. Known fountains are also problematic in so far as a substantial amount of chocolate is required simply to prime them. That is, a large amount of chocolate remains in the reservoir that will not travel to the fountain outlet.

Furthermore, known fountains also often require experienced users or operators due to the nature of the chocolate and the use of separate auger speed and temperature controls. The known fountains are also disadvantageous because chocolate remaining in the reservoir is often contaminated with edible materials that were coated with a liquid chocolate and follow the liquid chocolate flow path back to the reservoir blocking the lower chocolate inlet and restricting the augur efficiency.

### OBJECT OF THE INVENTION

It is an object of the invention to provide a viscous liquid reservoir for use with a viscous liquid fountain, and a viscous liquid fountain that will overcome or substantially ameliorate the deficiencies of the prior art, or to provide a useful alternative.

### SUMMARY OF THE INVENTION

According to a first aspect of the invention there is provided a viscous liquid fountain including:
a fountain foundation containing a motor and a heater, the motor including a drive shaft extending upwardly from the fountain foundation;
a viscous liquid reservoir mounted to the foundation and having one or more side walls extending a predetermined height above the base of the reservoir, the reservoir having a sleeve extending upwardly from the base of the reservoir a height being from half the side wall height to more than the side wall height, and
an auger configured for mounting over the sleeve and for engaging with the drive shaft to allow rotation of the augur.

Preferably, the viscous liquid reservoir base is sloped downwardly from the reservoir side walls to the sleeve by 10° to 40°.

Preferably, the viscous liquid fountain includes a transparent elongate auger cover configured for mounting over the augur to the base of the viscous liquid reservoir, the auger cover including one or more viscous liquid inlets disposed at or adjacent the reservoir base, the liquid inlets extending a predetermined distance above the reservoir base less than the height of the reservoir sleeve. More preferably, the auger cover includes a viscous liquid outlet at the opposite end to which it is mounted to the reservoir base, the augur cover including an augur stabiliser disposed adjacent the liquid outlet and configured for restraining lateral movement of the augur.

In preferred embodiments, the fountain includes a lower tier circumferentially disposed about the augur cover and radially extending therefrom a distance less than the width of the viscous liquid reservoir to provide a circumferential gap there between 4 mm and 20 mm. In other preferred embodiments, the fountain includes a lower tier circumferentially disposed about the augur cover and radially extending therefrom a distance equal to the width of the viscous liquid reservoir wherein at least an annular portion of the lower tier is a mesh material.

Preferably, the fountain includes a motor and heater controller configured to heat the viscous liquid reservoir to a predetermined temperature and to control the rotation of the augur. More preferably, the fountain includes a removable transparent fountain cover configured for mounting to the fountain foundation over the liquid reservoir and the augur.

In preferred embodiments, the fountain includes at least one drip tray detachably mounted to the fountain foundation, each drip tray configured to hold edible material and includes a fluid recess for draining fluid from the edible material.

According to another aspect of the invention there is provided a viscous liquid reservoir for use in a viscous liquid fountain, the reservoir including a reservoir base; one or more side walls extending a predetermined height above the reservoir base; and a sleeve extending upwardly from the reservoir base a height being from half the height of the reservoir side walls to more than the sidewall height, the sleeve configured to receive a motor drive shaft therethrough and to receive an auger thereover wherein the viscous liquid reservoir is mountable to a liquid fountain foundation.

Preferably, the fountain base is configured to retain a transparent augur cover disposed over the augur and the sleeve, and the augur cover includes one or more viscous liquid inlets disposed at or adjacent the reservoir base.

It can therefore be seen that there is provided a viscous liquid reservoir for use with a viscous liquid fountain and a viscous liquid fountain that is relatively easily cleaned and that does not result in large amounts of viscous liquid being collected by a reservoir that cannot be used by the fountain.

### BRIEF DESCRIPTION OF THE DRAWINGS

Preferred embodiments of the invention will now be described, by way of example only, with reference to the accompanying drawings in which:

FIG. 1 is a perspective view of a chocolate fountain according to a first preferred embodiment;

FIG. 2 is a cut away side view of the fountain of FIG. 1 with a fountain cover;

FIG. 3 is an elevated perspective view of the lower part of the fountain foundation of the fountain of FIG. 1;

FIG. 4 is an elevated perspective view of the heater and motor drive in an upper part of the fountain foundation of the fountain of FIG. 1;

FIG. 5 is an elevated perspective view of the chocolate reservoir of the fountain of FIG. 1;

FIG. 6 is an elevated perspective view of the chocolate fountain of FIG. 1 partly assembled;

FIG. 7 is an elevated perspective view of the chocolate fountain of FIG. 6 with the auger mounted;

FIG. 8 is a flow chart of the augur and temperature control of the fountain of FIG. 1; and

FIG. 9 is a cut away side view of a chocolate fountain according to another preferred embodiment.

### DETAILED DESCRIPTION

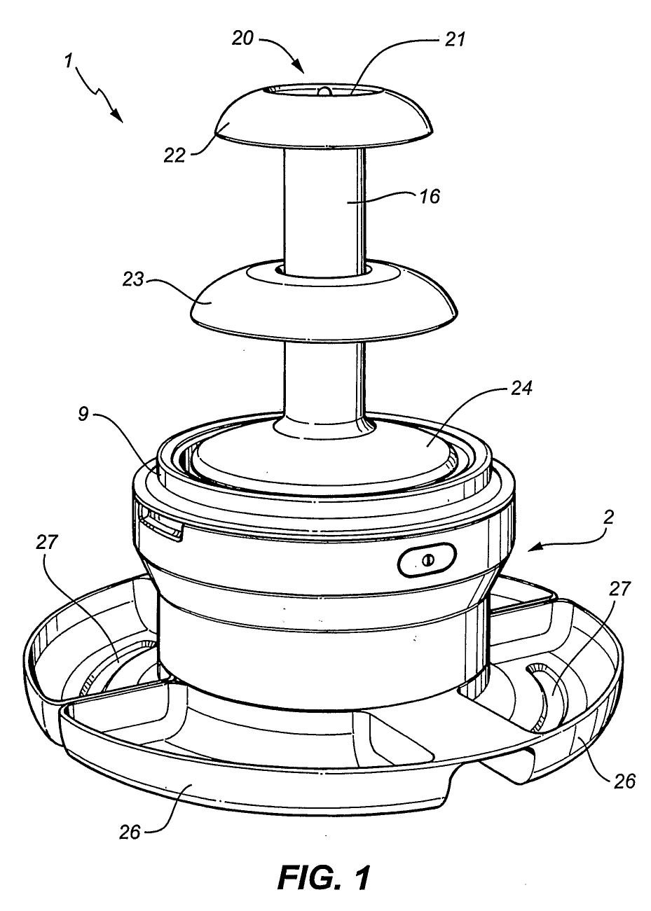

Referring to the FIGS. generally, like reference numerals are used to denote like components. In FIG. 1, there is shown a perspective view of a liquid chocolate fountain 1 according to a first preferred embodiment.

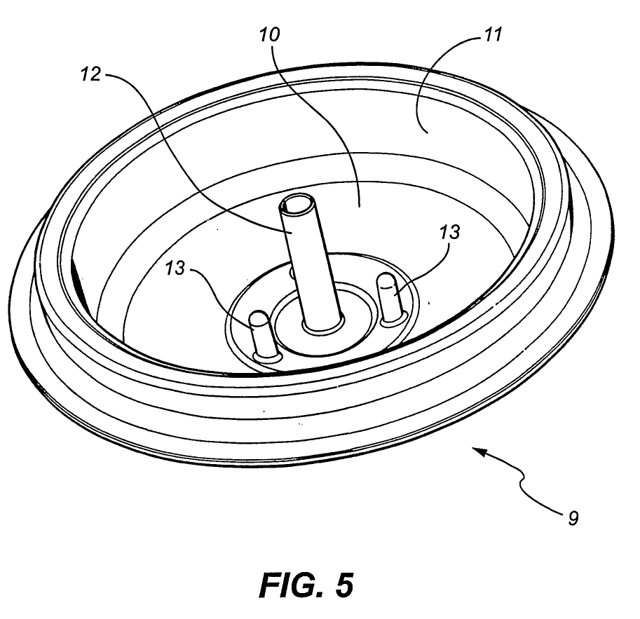

The chocolate fountain 1 includes a fountain foundation 2. The foundation 2 is formed from a lower foundation 3 and an upper foundation 4 mountable to the top of the lower foundation 3. As best seen in FIG. 4, the upper foundation 4 includes a chocolate heater 5 and an upwardly extending motor drive shaft 6.

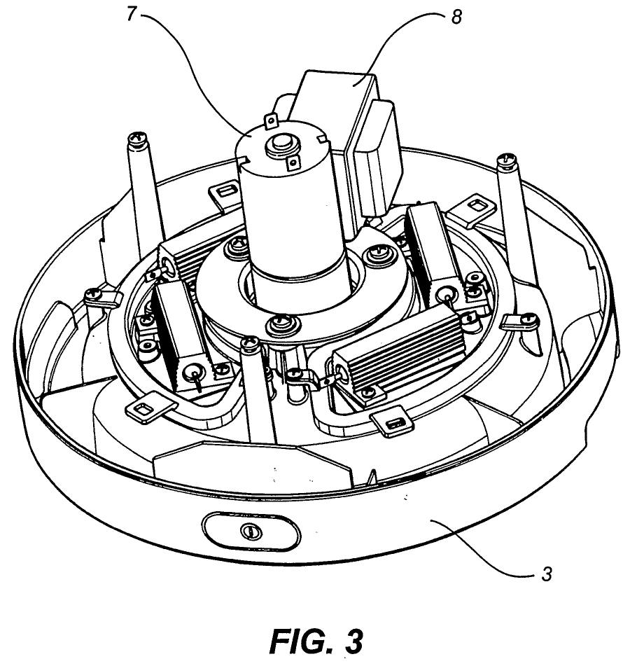

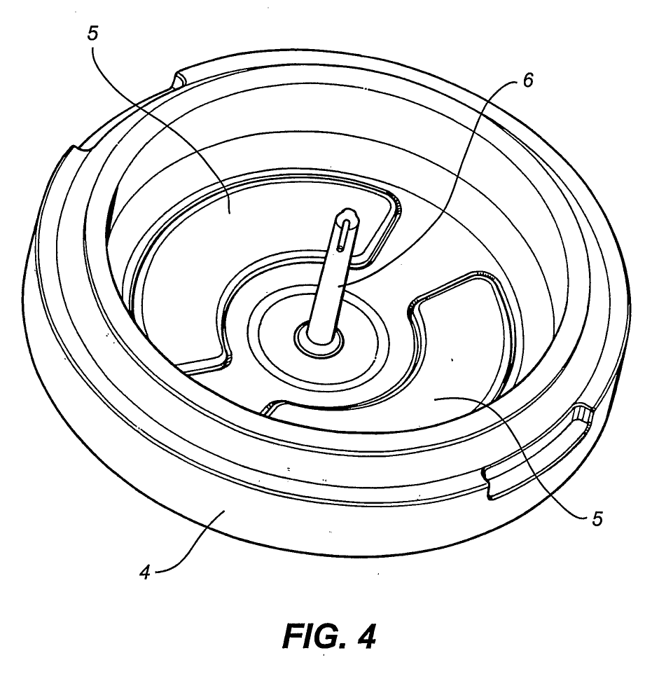

The lower foundation 3 includes a motor 7 configured to engage with the drive shaft 6 when the upper foundation 4 is mounted on the lower foundation 3. FIG. 3 shows motor 7 and various components such as a transformer 8 used to power the heater 5 and motor 7.

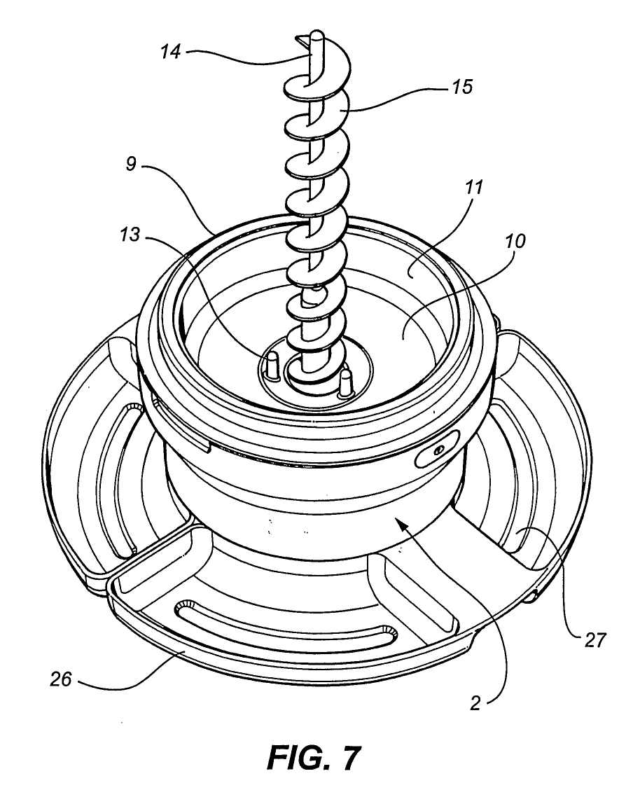

The upper foundation 4 is configured to receive a chocolate reservoir 9 as best shown in FIG. 6. The chocolate reservoir 9 includes a reservoir base 10 and a single side wall 11 extending a predetermined height above the reservoir base 10 to define a reservoir volume therein.

A sleeve 12 extends upwardly from the reservoir base 10 to substantially the height of the reservoir side wall 11. The sleeve 12 is configured to receive the motor drive shaft 6 therethrough when the reservoir 9 is mounted onto the upper foundation 4.

The base 10 of the chocolate reservoir 9 is sloped downwardly from the reservoir side wall 11 to the sleeve 12 by about 15°. However, the reservoir base 10 can slope downwardly at any angle, most preferably between 10° to 40°.

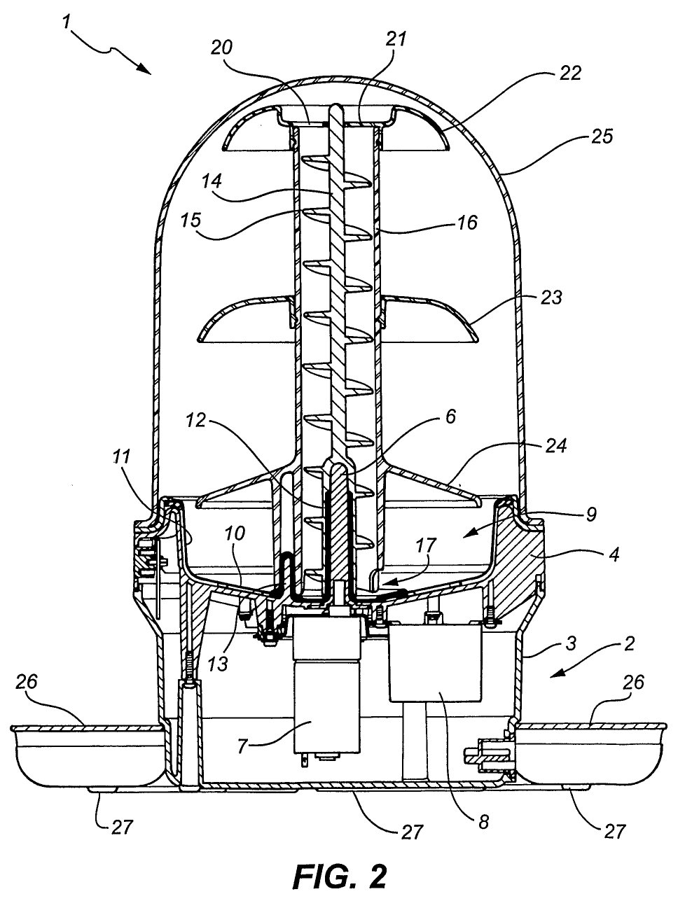

The sleeve 12 is configured to receive an augur 14 thereover such that the augur 14 engages with the motor drive shaft 6. The augur 14 extends from adjacent the reservoir base 10 to a predetermined height above it. As best shown in FIG. 2, the augur 14 and motor drive shaft 6 are configured for keyed engagement such that rotation of the shaft 6 causes the augur 14 to rotate.

The reservoir base 10 includes three projections 13 upwardly extending from the base 10 and disposed about the sleeve 12 and auger blade 15 diameter. Each projection 13 is configured to engage with a corresponding slot or depression disposed around a lower end of an auger cover 16. The augur cover 16 is transparent and includes at least one liquid chocolate inlet 17 at or adjacent the end of the cover 16 mounted to the projections 13. The chocolate inlet extends a predetermined height above the reservoir base 10. In the preferred embodiment, the inlet 17 height is approximately equivalent to the height difference of the base 10 caused by the 15° slope.

A liquid chocolate outlet 20 is disposed at the top end of the augur cover 16. The augur 14 extends substantially the same distance from the reservoir base 9 as the transparent augur cover 16. An augur stabiliser 21 is mounted to the top end of the augur cover 16 and engagable with the top end of the augur 14 to restrain lateral movement of the augur 14. As best shown in FIG. 2, the augur stabiliser 21 is a plate material with a central aperture to receive the top of the augur 14 and at least one other aperture to allow liquid chocolate to pass therethrough and out.

Cascading tiers 22, 23, 24 are removably mounted along the augur cover 16. The tiers extend a predetermined radial distance from the augur cover 16 where the radial distance increases from upper tier 22 to the lowest tier 24, and the tiers slope downwardly a predetermined amount. The lowest tier 24 has a smaller diameter than the reservoir side wall 11 so that a circumferential or annular gap is left between the lower tier 24 and the reservoir side wall 11. This gap is most preferably between 4 mm and 20 mm.

In use, liquid chocolate is passed up the augur 14 through the outlet 20 and over the upper tier 22. This then flows down onto the second tier 23 and then flows down to the lowest tier 24. The flow then travels over the tier 24 back into the reservoir between the gap between the reservoir side wall 11 and the lowest tier 24.

The chocolate fountain 1 includes a fountain cover 25. The fountain cover 25 is transparent and formed from a plastics or glass material. The cover 25 is fitted over the augur cover 16 and abuts the upper end of the side wall 11. A latch, clamp, or like restraint can be used to secure the cover 25 if necessary. The cover 25 is intended to seal the contents of the chocolate fountain 1 from contaminants.

Two drip trays 26 are also provided to hold edible materials to be coated by liquid chocolate. The trays 26 are detachably mounted around the circumference of the lower foundation 3. The trays include a fluid recess 27 for draining excess fluid from the edible materials to allow better coating of the material with liquid chocolate. The fluid recesses are best seen in FIG. 6.

In use, a predetermined weight of chocolate is put in the chocolate reservoir 9. The chocolate is heated up to a predetermined temperature by the heater 5 until it possesses desired viscosity and flow properties. Once the chocolate is in a liquid form, the augur 14 is rotated and the liquid chocolate is caused to move under gravity from the reservoir 9 through the augur cover inlet 17 and onto the augur blade 15.

As the augur 14 is rotated, liquid chocolate is moved up the augur and deposited at the auger outlet 20. The liquid chocolate then flows under gravity over the uppermost tier 22 and over its edge. The flow then falls onto the middle tier 23 and then onto the lowest tier 24. The liquid chocolate then flows over the edge of the lowest tier 24 through the gap between the reservoir side wall 11 back into the reservoir 9. At any time from exiting the augur cover outlet, the liquid chocolate flow can be used to partially or fully coat an edible material with chocolate.

It can be seen that the sloped base 10 allows a minimum amount of chocolate to be required to produce a fountain of liquid chocolate. Furthermore, the chocolate reservoir 9 can be easily removed and cleaned. The gap between the lowest tier 24 and the reservoir side wall 11 is chosen to allow the flow of liquid chocolate but restrain the flow of any contaminants that have fallen into the chocolate flow. It can also be seen that the sleeve 12 provides a reservoir that does not need seals or the like between its contents and the motor and heater below, thereby allowing for easier cleaning.

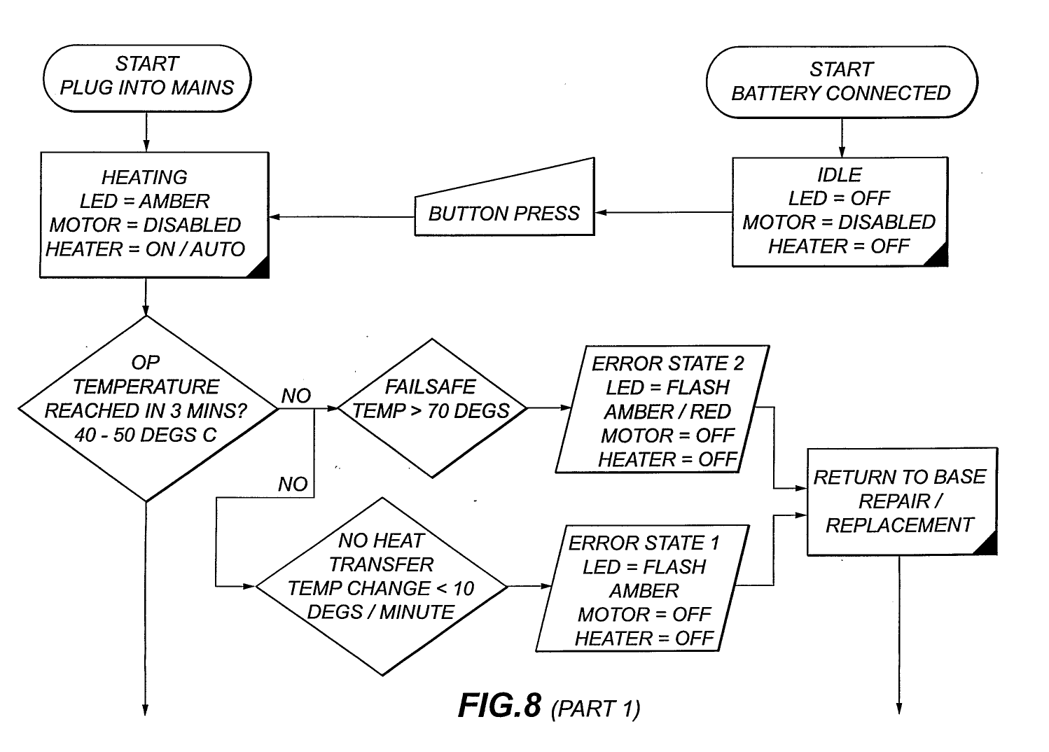

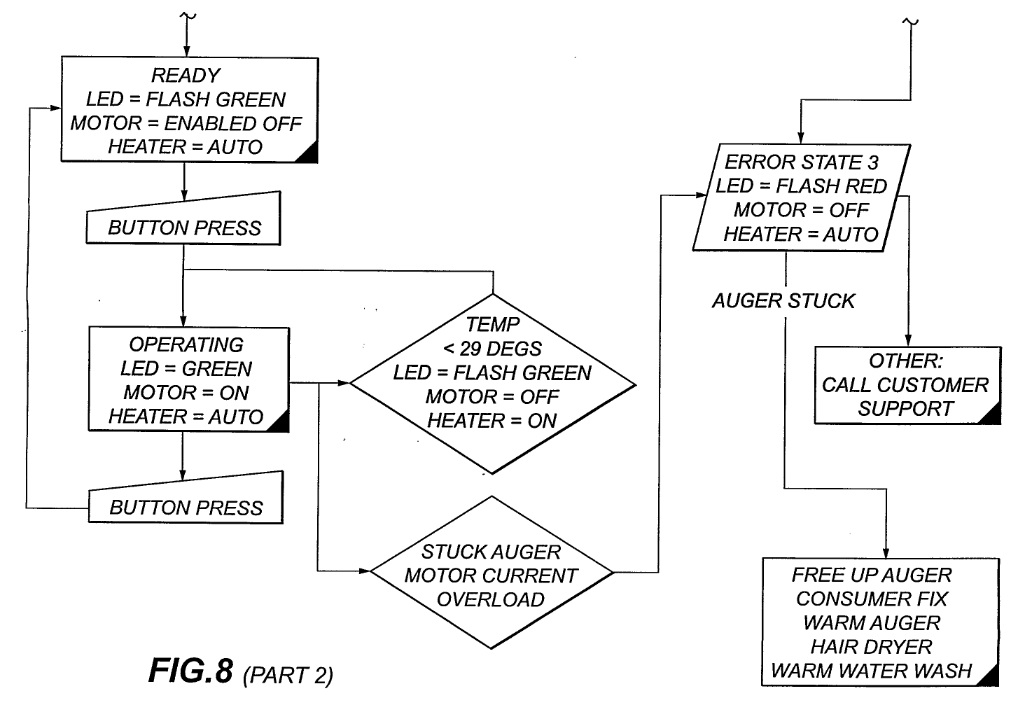

Referring to FIG. 8, there is shown a flow chart showing the logic of controlling the rotational speed of the augur 14 and temperature of the heater 5. Starting at the top left or right of the flow chart, connecting the fountain 1 to mains electricity instigates heating of the contents of the reservoir 9. If the fountain 1 is connected to a battery source, a user is required to depress a button to commence the heating process. At this stage, the augur 14 is not rotated and a display in the form of a multicoloured LED indicates that the heater 5 has started but the augur 14 not rotated by glowing an amber colour.

For a predetermined chocolate operating temperature, 40° C. to 50° C. in FIG. 8, it is expected that this will be reached within a predetermined period of time, 3 minutes. If this does not happen, an error has occurred where the temperature had increased too high or not at a sufficient rate and an alarm condition is indicted by the fountain 1. The fountain 1 will automatically disconnect power to the heater 5 and the augur motor 7 under such an alarm condition.

If the temperature of the chocolate in the reservoir 9 reaches the predetermined temperature in an expected period of time, the LED display indicates this by flashing green. The augur motor 7 is then manually or automatically rotated from an initial speed of zero rpm to a maximum preferred rpm. When this occurs, the LED will be solid green. If the temperature of the chocolate in the reservoir drops below a predetermined value, approximately 29° to 32° in FIG. 8, the heater 5 is powered on. If the augur gets stuck and fails to rotate, the back EMF of the motor, for example, will indicate this and the motor automatically disabled. An alarm condition is provided and the user can try mechanically freeing the augur or heating about its base to loosen any hardened viscous liquids restraining the augur from rotating.

It can be seen that by using a transparent augur cover 16 the user can observe the start up of the fountain 1 and the flow of the chocolate without having to expose it to the atmosphere and possible contaminants.

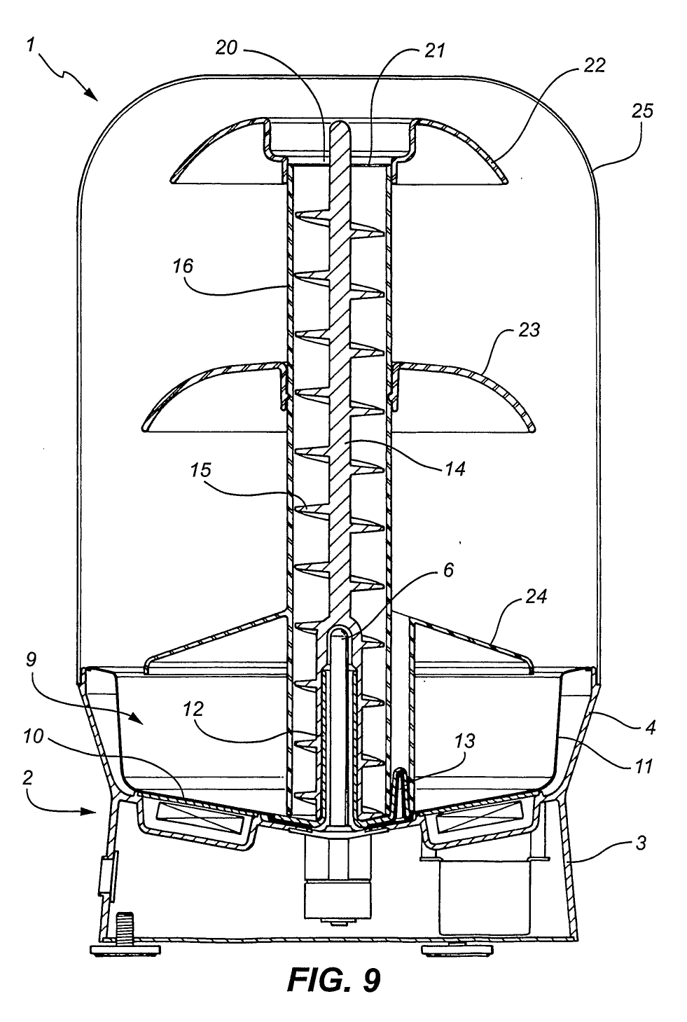

Referring to FIG. 9, there is shown a cut away side view of a chocolate fountain 1 according to another preferred embodiment. As earlier noted, like reference numerals are used to denote like components.

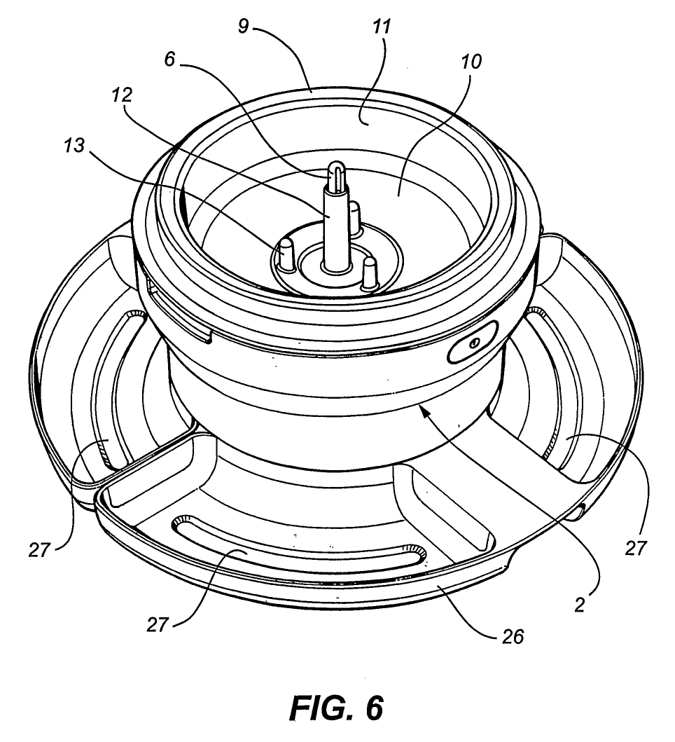

The fountain 1 of FIG. 9 is of a similar view to FIG. 2 but with fewer components illustrated, such as motor 7, transformer 8 and trays 26. The fountain 1 of this embodiment operates in the same manner as the fountain 1 described with reference to FIGS. 1 to 8, and provides the same advantages of minimising the amount of viscous liquid required for priming the fountain 1 and also enables the fountain to be relatively effectively and efficiently cleaned.

It can be seen that the fountain 1 advantageously utilises a viscous liquid reservoir 9 including a reservoir base 10 and one continuous circular side wall 11 extending a predetermined height above the reservoir base 10. A sleeve 12 extends upwardly from the reservoir base 10 a height being about the height of the side wall 11. It will be appreciated that as with the first preferred embodiment described above, the sleeve 12 extend above the base 10 a height from half the side wall 11 height to more than the sidewall 11 height. The sleeve 12 is configured to receive a motor drive shaft 6 therethrough and to also receive an auger 14 thereover such that the reservoir 9 is mountable to a liquid fountain foundation.

The foregoing describes only one embodiment of the present invention and modifications, obvious to those skilled in the art, can be made thereto without departing from the scope of the present invention. For example, any preferred heater and augur controller and display can be used, and the fountain foundation can be contained in a single housing with an upper end configured to receive the chocolate reservoir 9.

Other variations include broadening the diameter of the lowest tier 24 so that there is a minimal or no gap between the tier 24 and side wall 11. In such an embodiment, part or all of the tier periphery can be formed from a mesh or straining material to remove contaminants above a predetermined size. Further higher tiers may also be added or removed depending on the visual effect to be achieved.

It is noted that the three projections 13 extending up from the reservoir base 10 can be replaced by equivalent elements such as more or less or differently shaped projections. A keyed arrangement between the augur cover 16 and the base 10 instead of the projections 13 can also be employed provided that the augur cover 16 is held securely to the base 10.

The motor drive shaft 6 can extend more than, less than, or equal to the height of the sleeve 12, and the reservoir side wall 11 can be formed from more than one side wall 11.

As noted above, the fountain 1 can be used for more than chocolate and is applicable for use with other viscous liquids such as honey, cheese, gravy, nougat, mustard, sauces or other viscous liquids to coat edible materials with.

1. A viscous liquid fountain including:
a fountain foundation containing a motor and a heater, the motor including a drive shaft extending upwardly from the fountain foundation;
a viscous liquid reservoir mounted to the foundation and having one or more side walls extending a predetermined height above the base of the reservoir, the reservoir having a sleeve extending upwardly from the base of the reservoir a height being from half the side wall height to more than the side wall height; and
an auger configured for mounting over the sleeve and for engaging with the drive shaft to allow rotation of the augur.

2. The viscous liquid fountain according to claim 1 wherein the viscous liquid reservoir base is sloped downwardly from the reservoir side walls to the sleeve by 10° to 40.

3. The viscous liquid fountain according to claim 1 including a transparent elongate auger cover configured for mounting over the augur to the base of the viscous liquid reservoir, the auger cover including one or more viscous liquid inlets disposed at or adjacent the reservoir base, the liquid inlets extending a predetermined distance above the reservoir base less than the height of the reservoir sleeve.

4. The viscous liquid fountain according to claim 3 wherein the auger cover includes a viscous liquid outlet at the opposite end to which it is mounted to the reservoir base, the augur cover including an augur stabiliser disposed adjacent the liquid outlet and configured for restraining lateral movement of the augur.

5. The viscous liquid fountain according to claim 4 including a lower tier circumferentially disposed about the augur cover and radially extending therefrom a distance less than the width of the viscous liquid reservoir to provide a circumferential gap therebetween.

6. The viscous liquid fountain according to claim 4 including a lower tier circumferentially disposed about the augur cover and radially extending therefrom a distance equal to the width of the viscous liquid reservoir wherein at least an annular portion of the lower tier is a mesh material.

7. The viscous liquid fountain according to claim 1 including a motor and heater controller configured to heat the viscous liquid reservoir to a predetermined temperature and to control the rotation of the augur.

8. The viscous liquid fountain according to claim 1 including a removable transparent fountain cover configured for mounting to the fountain foundation over the liquid reservoir and the augur.

9. The viscous liquid fountain according to claim 1 including at least one drip tray detachably mounted to the fountain foundation, each drip tray configured to hold edible material and includes a fluid recess for draining fluid from the edible material.

10. A viscous liquid reservoir for use in a viscous liquid fountain, the reservoir including a reservoir base; one or more side walls extending a predetermined height above the reservoir base; and a sleeve extending upwardly from the reservoir base a height being from half the height of the reservoir side walls to more than the sidewall height, the sleeve configured to receive a motor drive shaft therethrough and to receive an auger thereover wherein the viscous liquid reservoir is mountable to a liquid fountain foundation.

11. A viscous liquid reservoir according to claim 10 wherein the fountain base is configured to retain an augur cover disposed over the sleeve and an augur, the auger cover including one or more viscous liquid inlets disposed at or adjacent the reservoir base.

12. A viscous liquid reservoir according to claim 10 wherein the reservoir base is sloped from the side walls to the sleeve by 10° to 40°.
